(19) United States
(12) Patent Application Publication
(10) Pub. No.: US 2004/0151311 A1
(43) Pub. Date: Aug. 5, 2004

(54) Encrypted photo archive

(76) Inventors: Max Hamberg, Vantaa (FI); Jari Leppaniemi, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/619,176

(22) Filed: Jul. 15, 2003

Related U.S. Application Data
(60) Provisional application No. 60/444,657, filed on Feb. 4, 2003.

(51) Int. Cl. H04L 9/00

(52) U.S. Cl. 380/44

(57) ABSTRACT

A system for encrypting a first set of data includes a generating means for generating a second set of data representative of the first set of data. The system also includes an encrypting means for encrypting the first set of data using the second set of data.

### CROSS-REFERENCE TO RELATED APPLICATIONS

This application claims priority of U.S. Provisional Application Serial No. 60/444,657 entitled, “Encrypted Photo Archive,” filed Feb. 4, 2003, the entire contents of which are incorporated herein by reference.

### BACKGROUND OF THE INVENTION

1. Field of the Invention

The present invention relates to the encryption, storage and access control of data in a communication system, and in particular, but not exclusively, to the encryption and storage of data.

2. Description of the Related Art

In the advent of digital photography, an increasing number of end user devices that are capable of connecting to networks such as the internet, now incorporate digital cameras. Such devices include mobile phones, personal digital assistants (PDAs) and personal computers (PCs).

Photographs taken by devices with digital cameras may be stored in the memory of the device. However, end user devices may have a limited amount of memory in which to store digital images. Mobile phones in particular have a relatively small amount of memory in which to store digital images.

It has been suggested that storage means are provided in the network on which a subscriber may store digital images. Access to the archives is currently restricted by strict and complex access control methods like access control lists that contain information on who is allowed to browse the stored images. The privacy of the stored images is compromised as the administrators and system maintenance staff have access to the access control data and also to the stored data.

### SUMMARY OF THE INVENTION

It is therefore an aim of embodiments of the present invention to overcome the disadvantages of current access control systems described above.

According to one embodiment of the present invention there is provided a method of encrypting a first set of data comprising the steps of generating a second set of data representative of the first set of data; and encrypting the first set of data using the second set of data.

Preferably the first set of data is encrypted by performing a symmetric key based encryption algorithm between the first set of data and the second set of data.

Preferably the second set of data is a reduced version of the first set of data.

Preferably the first set of data is one of a digital photograph, a picture or a text document, an audio file, or multimedia message.

Preferably the second set of data is one of a thumbnail image, an extract from an audio file or a picture of a multimedia message.

Preferably the encrypted first set of data is decrypted by performing an exclusive OR operation between the encrypted first set of data and the second set of data.

According to a another embodiment of the present invention there is provided a communications system for encrypting a first set of data comprising: a capturing means for capturing the first set of data; generating means for generating a second set of data representative of the first set of data; and encrypting means for encrypting the first set of data using the second set of data.

Embodiments of the present invention therefore provide easy and secure access to archived digital images.

Embodiments of the present invention may further provide efficient and cost effective ciphering.

The efficiency and simplicity of methods that are in accordance with embodiments of the present invention may optimise resource consumption in end user devices and in archives.

A further advantage of embodiments of the present invention is that there may be no need for administrators to have access to the secured information.

A further advantage of embodiments of the present invention is that using an image which is representative of the original image as a ciphering key may provide an extremely useful description of the content of the original image.

### BRIEF DESCRIPTION OF THE DRAWINGS

Embodiments of the present invention will now be described by way of example only with reference to the accompanying drawings, in which:

FIG. 1 is a simplified presentation of a cellular network;

FIG. 2 is a schematic diagram of a communication network;

FIG. 3 is a flow chart showing steps of a method in accordance with an embodiment of the present invention;

FIG. 4 is a further flow chart showing steps that are in accordance with an embodiment of the present invention.

FIG. 5 is a diagram showing schematically an embodiment of the present invention; and

FIG. 6 is a diagram showing an alternative embodiment of the present invention.

### DETAILED DESCRIPTION OF THE PREFERRED EMBODIMENTS

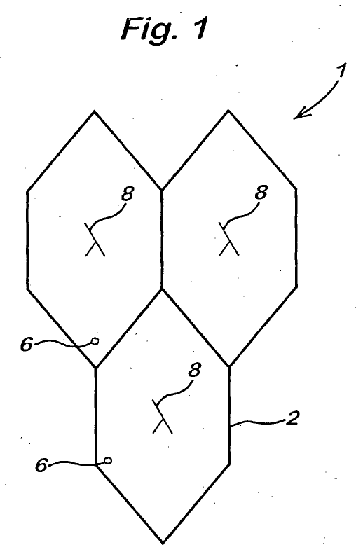

Reference is first made to FIG. 1 which is a simplified presentation of a cellular system. It should be appreciated that even though the exemplifying telecommunications network shown and described in more detail uses the terminology of the third generation (3G) UMTS (Universal Mobile Telecommunications System), embodiments of the present invention can be used in any other suitable form of network.

More particularly, FIG. 1 shows an arrangement in which base stations 8 (only three shown for clarity) of the cellular system 1 provide radio coverage areas i.e. cells 2. Each radio coverage area 2 is typically served by a base station. It should be appreciated that one cell may include more than one base station site. A base station apparatus or site may also provide more than one cell. The shape and size of the cells 2 depend on the implementation and may be different from the illustrated shapes. It should be appreciated that in some systems the base station may be referred to as Node B.

Two user equipment (UE) 6 are also shown. It shall be appreciated that typically a number of user equipment will be in communication with each base station. Each base station is arranged to transmit signals to and receive signals from the mobile user equipment (UE) 6 via a wireless interface. Likewise, the user equipment 6 are able to transmit signals to and receive signals from the base stations.

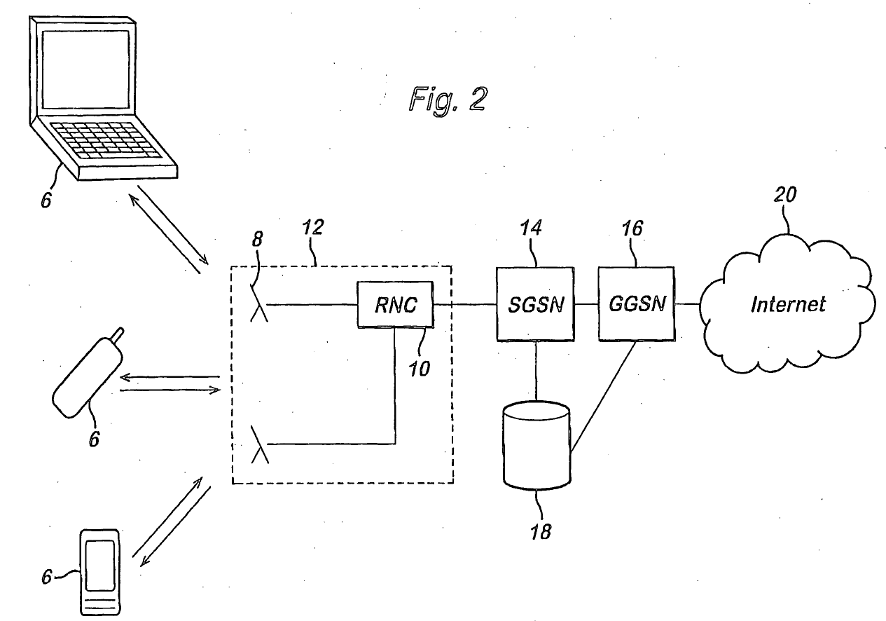

Each of the base stations is connected to an access network controller such as a radio network controller (RNC) 10 of a UMTS terrestrial radio access network (UTRAN) (shown in FIG. 2). The radio network controller may be connected to appropriate core network entities of the cellular system, such as an SGSN (serving general packet radio service support node) 14 for packet switched communication and additionally an MSC (mobile switching centre) for circuit switched communication.

FIG. 2 depicts part of the architecture of a UMTS (universal mobile telecommunications network). This shows a plurality of user equipment 6 such as PDAs (Personal Digital Assistants), mobile phones and laptops; a radio access network (RAN) 12 comprising base stations 8 and an RNC (radio network controller) 10; an SGSN (serving GPRS support node) 14; a GGSN (gateway GPRS support node) 16; and a network server archive 18. The Internet is depicted by reference 20. In FIG. 2 the network server archive 18 is directly connected to an operator's GPRS via the SGSN 14 or GGSN 16. In an alternative embodiment, the network server archive may be connected to an operator's SGSN through the internet.

The implementation of the RAN 12, SSGN 14 and GGSN 16 are well known in the art, and for the purposes of the discussion of embodiments of the present invention it is assumed that they operate in accordance with standard, known techniques except where stated.

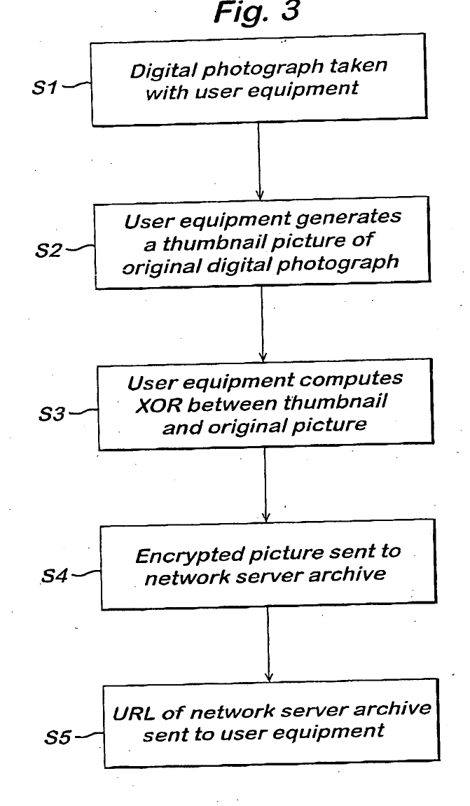

The network server archive 18 is used as a database for storing data such as digital images and text files created by user equipment 6. In a preferred embodiment of the present invention, the network server archive 18 stores digital images that have been encrypted. The unencrypted images need not ever go to the database which ensures the privacy. The database may be accessed also from the Internet without going via GPRS network. The manner in which a data such as a digital image created by a user equipment 6 is encrypted and stored on the network server archive 18 will now be described with reference to FIG. 3.

In step 1 (S1) of FIG. 3, a user captures a digital image using a piece of user equipment. For example, the user may take a digital photograph using a piece of user equipment such as a mobile phone that has a digital camera. As an alternative example the user may receive a digital image such as a digital photograph from a third party who has created the image and sent it to the user by email. In a further alternative embodiment the user may create a data file such as a Word™, Excel or Powerpoint file, that may be encrypted and stored on the network archive server. It should be clear that a person skilled in the art would easily and immediately understand that the term “image” may be any such file type from which a compacted form could be created—for example the compacted form may comprise a thumbnail of a photograph, few bars of music from a musical stream, or a picture of a multimedia message etc.

If the user decides that he wants to store the digital image on a network server archive for some reason, for example, because there is a limited amount of memory user equipment, the user begins the encryption process at step 2 (S2). The original digital image is then temporarily stored in the memory of the mobile phone.

In S2 a thumbnail image of the original digital image is created. This may be achieved using an image processing software that is installed on the user equipment or downloadable from the network. The thumbnail image is a lower resolution version of the original image. The thumbnail image may be produced resampling the original photograph at a lower resolution, for example, with a maximum width and height of approximately 100 pixels. The downsampling may be done using known sampling schemas like 4-2-2, 4-2-0 etc. For example, A thumbnail image may be created by selecting m×n pixels from an original image of p×q pixels where m and n are less than p and q. Alternatively a thumbnail image may be generated by averaging the intensity and colour of a selected group of pixels of the original image to generate a single pixel of the thumbnail image. The thumbnail image accordingly occupies a much smaller memory space than the original image. Once the thumbnail image has been generated it is stored together with the original image in the memory of the user equipment 6.

In an alternative embodiment of the present invention, the thumbnail image may be created by another entity instead of the user equipment. For example the user may transmit a copy of the original image to a server that generates the thumbnail image. The server may then transmit the thumbnail to the user equipment of the user. In order to protect the information in the original image, the server that has generated the thumbnail image may delete the copy of the original image once it has generated the thumbnail.

In step 3 (S3), the original digital photograph is encrypted in the user equipment using a key based symmetric encryption method such as Exclusive OR (XOR) encryption. In a preferred embodiment of the original digital photograph is encrypted using the thumbnail image of the original picture as the key. This is achieved by performing a bitwise XOR operation on each byte of the original photograph with each byte of the thumbnail image. In case of XOR encryption some or all of the bytes of the thumbnail image are used more than once. After the encrypted image has been successfully generated, the original digital picture may be deleted from the memory or for example in case of XOR the result of encryption may be stored directly over the original image thus needing not (any additional) memory to store both the original and the encrypted images.

In an alternative embodiment of the present invention the encryption step may be performed by another entity instead of the user equipment. For example the user may transmit a copy of the original image to a server together with the thumbnail image. Alternatively the server may create the thumbnail image as previously described. The server may then encrypt the image using a method previously described and transmit the encrypted image either to the network archive server 18 or to the user equipment. In order to protect the information in the original image, once the server that has generated the encrypted image, the server may delete the copy of the original image and the thumbnail once it has generated the encrypted image.

In step 4 (S4) the encrypted image is transmitted from the user equipment to the network server archive 18. This could be an operator service e.g. downloadable java-applet or it could be a feature as dedicated menu item, a configuration parameter in the software/phone or provisionable parameter in operator's subscriber database.

Service can be chargeable by different means e.g. monthly fee, per used megabyte (MB) of memory space at the network archive server or transaction based etc.

When the encrypted image is received at the network server archive 18, the network server archive stores the encrypted photograph at a particular location in e.g. a database or server file system. One major benefit here is that no special Database software is actually needed, plain operating system file systems can be used, because the secured images can be stored in normal directories without major access control parameters, thus making the server side very simple and cheap.

The exact location in the database at which the encrypted photograph is stored, is identified by a uniform resource locator (URL). In step 5 (S5), the network server archive transmits the URL to the user equipment 6. The URL can be structured e.g. as a server domain name, and an e.g. hexadecimal integer telling the file system directory where the image is stored: www.fotarc.com/0000001 to www.fotarc.com/FFFFFFF. The directory path of the URL need not to be more complex than an integer, but it can be more complex. A simple URL spares the memory in the user device.

The thumbnail image and the URL are then stored together in the memory of the user equipment. A plurality of thumbnail images and URLs that correspond to encrypted images stored on the database of a network server archive may be stored in the limited memory of the user equipment, since thumbnail images and URLs only require small amounts of memory space. For example the original image may be 10 to 2000 Kbytes but the thumbnail may be only 1-2 Kb and the URL may be one byte for each character of the URL. The URL may be a limited size, for example: www.secureimages.com/FFFF..FF.htm for a FFFF..FF (HEX) amount of different images

In an alternative embodiment of the present invention the URL may be stored in the thumbnail image as a watermark so that the URL may be extracted from the thumbnail if the location of the URL in the thumbnail is known.

In a further alternative embodiment the URL may be derivable from the thumbnail using a formula. For example, the first byte of the URL may represent the size of the thumbnail and the bytes of the URL can be distributed around the thumbnail.

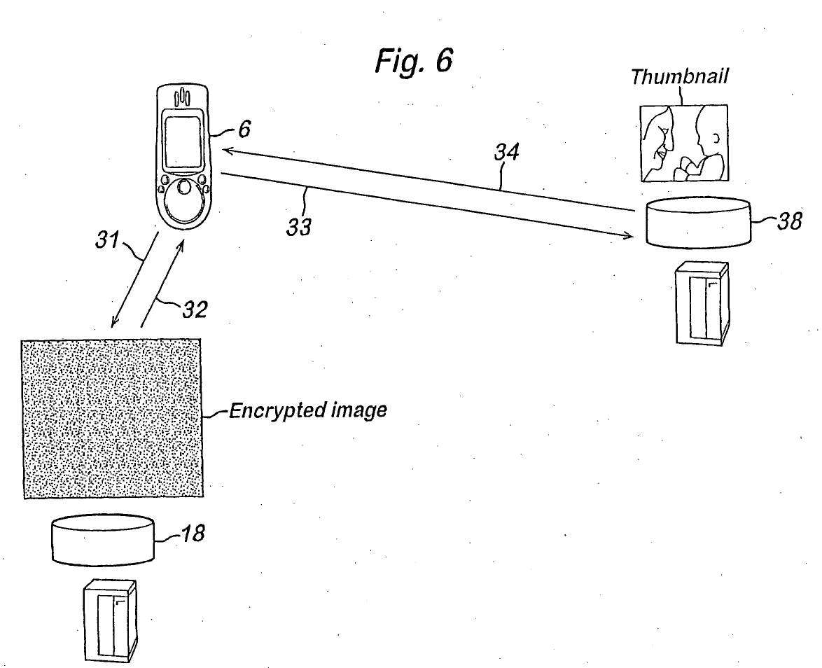

In a further alternative embodiment of the present invention, thumbnail images can be stored in a further archive server in the network, as shown in FIG. 6. This embodiment of the present invention may be implemented when the used amount of memory in the user device is minimized. In accordance with one of the methods described above the user terminal transmits the encrypted image, represented by arrow 31, to network archive 18. In response the network archive 18 transmits the URL of the location of the encrypted image, represented by arrow 32, to the terminal 6. The terminal 6 further transmits the thumbnail, represented by arrow 33 to a thumbnail archive server 38. The thumbnail archive server 38 receives and stores the thumbnail at a location on a database at the server. The server 38 then transmits a URL of the location at which the thumbnail is stored, represented by arrow 34, to the terminal 6. In this case the URL of the encrypted large picture and the URL of the thumbnail are different, and the mapping between these two is located to the end user device. However, in this case, the association between thumbnail and the large image is lost. Furthermore, the thumbnails stored at the further network archive server are not securely stored and therefore may be viewed by third parties.

The user may therefore download the encrypted image that is stored at the network archive server using the URL and decrypt the image using the thumbnail which is either stored at a further network server or the stored on the user device. The decryption method is explained in more detail hereinafter.

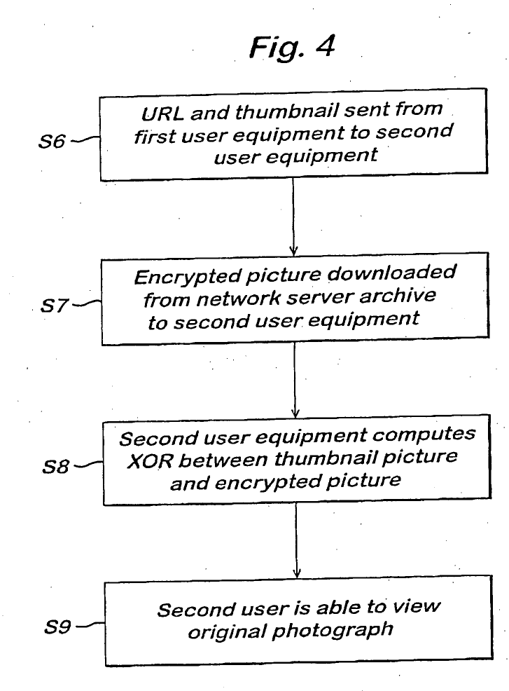

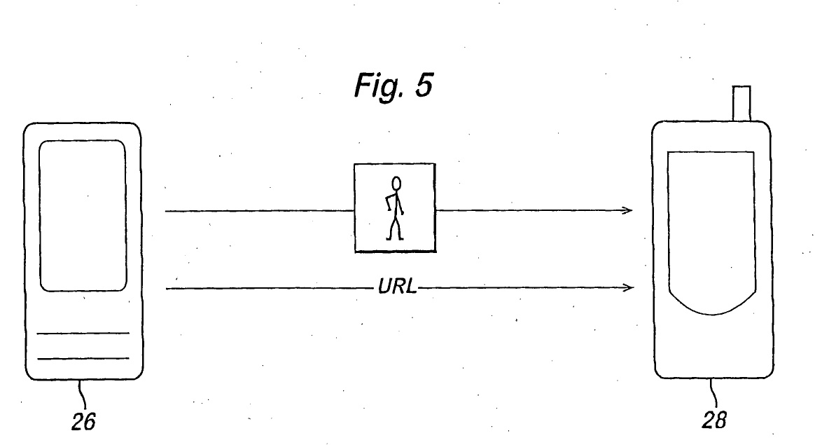

Reference is now made to FIGS. 4 and 5 which describe an embodiment of the present invention performed when a user 26 wishes to allow a user 28 of another piece of user equipment capable of processing digital photographs to download the original picture.

In step 6 (S6), the user 26 transmits the URL and corresponding thumbnail picture that is stored in the memory of the user equipment to the user equipment of another user 28. This may be sent via a cellular network (not shown) or alternatively across a mobile ad hoc network (MANET) or by any other means.

The URL may be sent separately from the thumbnail to the other user 28. Alternatively, if the decryption software stored on the user equipment of the other user 28 is configured to allow it to first extract the URL from a thumbnail URL pair [thumbnail, URL], the URL and the thumbnail and URL may be sent together as a thumbnail URL pair, in which the URL is embedded in the thumbnail.

If the user equipment of the user 28 is capable of displaying digital images, the user 28 may decide if they want to download the original picture by viewing the thumbnail picture.

If the user 28 decides to download the original photograph, the user 28 requests the encrypted photograph from the URL. In step 7 (S7), the encrypted image is downloaded from the network server archive to the user equipment of user 28 and stored temporarily in the memory of the user equipment.

Since the following is always true: if ((a XOR b)=c) then ((c XOR a)=b), performing a bitwise XOR operation on each byte of the encrypted image with each byte of the thumbnail image results in the original image. Therefore at step 8 (S8), the user equipment of user 28 performs an XOR operation between the thumbnail image and the encrypted photograph.

At step 9 the user 28 may process the original image, for example by viewing the image or by printing it out.

It may be the case that the user 26 wishes the other user 28 to only view the original image once. The URL may be created so that it is accessible only once—i.e. the encrypted image is destroyed after first access leading to situation that the URL is unusable.

Embodiments of the present invention have been described with specific reference to the UMTS and GPRS systems. However, it is not limited to these systems.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

1. A method of encrypting a first set of data comprising the steps of:
generating a second set of data representative of a first set of data; and
encrypting the first set of data using the second set of data.

2. A method as claimed in claim 1, wherein the first set of data is encrypted by performing a symmetric key based encryption algorithm between the first set of data and the second set of data.

3. A method as claimed in claim 1, wherein the first set of data is encrypted by performing an exclusive OR operation between the first set of data and the second set of data.

4. A method as claimed in claim 1, wherein the first set of data comprises digital data.

5. A method as claimed in claim 1, wherein the second set of data comprises a reduced version of the first set of data.

6. A method as claimed in claim 1, wherein an encrypted first set of data is stored at a first node.

7. A method as claimed in claim 6, further comprising the step of:
storing the second set of data in a memory of a second node.

8. A method as claimed in claim 7, further comprising the step of storing the second set of data at a third node.

9. A method as claimed in claim 6, further comprising the steps of transmitting the encrypted first set of data from the second node to the first node.

10. A method as claimed in claim 6, further comprising the step of storing the encrypted first set of data at a location on said first node.

11. A method as claimed in claim 6, further comprising the step of transmitting address information of a location at which the first set of data is stored, from said first node to said second node.

12. A method as claimed in claim 11, wherein the address information of the location at which the encrypted first set of data is stored is a URL.

13. A method as claimed in claim 8, further comprising the step of storing the second set of data at a location on said third node.

14. A method as claimed in claim 13, further comprising the step of transmitting address information of the location at which the second set of data is stored, from said third node to said second node.

15. A method as claimed in claim 14, wherein the address information at which the second set of data is stored is a URL.

16. A method as claimed in claim 6, further comprising the step of decrypting the encrypted first set of data using the second set of data.

17. A method as claimed in claim 6, further comprising the step of decrypting the encrypted first set of data by performing an exclusive OR operation between the encrypted first set of data and the second set of data.

18. A method as claimed in claim 6, further comprising the steps of decrypting the encrypted first set of data and transmitting a request to download the encrypted first set of data to the address of a location at which the encrypted first set of data is stored.

19. A method as claimed in claim 6, further comprising the steps of decrypting the encrypted first set of data and downloading the encrypted set of data from the first node to the second node.

20. A method as claimed in claim 19, further comprising the steps of decrypting the encrypted first set of data and downloading the second set of data from the third node to the second node.

21. A method as claimed in claim 6, wherein the second set of data is generated at a second node.

22. A method as claimed in claim 6, wherein the first set of data is encrypted at the second node.

23. A method as claimed in claim 6, wherein the first node comprises a first network archive server.

24. A method as claimed in claim 7, wherein the second node comprises a piece of user equipment.

25. A method as claimed in claim 8, wherein the third node comprises a second network archive server.

26. A method as claimed in claim 24, wherein the user equipment comprises one of a mobile station, a digital camera, a personal digital assistant or a personal computer.

27. A method as claimed in claim 1, wherein the first set of data comprises one of a digital photograph, a picture or a text document, an audio file, or multimedia message.

28. A method as claimed in claim 1, wherein the second set of data comprises one of a thumbnail image, an extract from an audio file or a picture of a multimedia message.

29. A method as claimed in claim 7, wherein the first set of data is created by the second node.

30. A method as claimed in claim 7, wherein the first set of data is received at the second node from a third party.

31. A method as claimed in claim 7, wherein address information of a location at which the encrypted first set of data is stored, and the second set of data are sent to a third party.

32. A method as claimed in claim 11, wherein the address information of the location at which the encrypted first set of data is stored, is stored in the second set of data as a watermark.

33. A method as claimed in claim 11, wherein the address information of the location at which the encrypted first set of data is stored is derivable from the second set of data.

34. A system for encrypting a first set of data comprising:
generating means for generating a second set of data representative of the first set of data; and
encrypting means for encrypting the first set of data using the second set of data.

35. A system according to claim 33, wherein the encrypting means is arranged to encrypt the first set of data by performing a symmetric key based algorithm between the first set of data and the second set of data.

36. A system according to claim 33, wherein the encrypting means is arranged to encrypt the first set of data by performing an exclusive OR operation between the first set of data and the second set of data.

37. A system as claimed in claims 33, further comprising a first node comprising storage means configured to store an encrypted first set of data.

38. A system as claimed in claim 36, further comprising a second node comprising storage means configured to store the second set of data.

39. A system as claimed in claim 37, further comprising a third node comprising storage means configured to store the second data.

40. A system as claimed in claim 33, wherein the second node further comprises said encrypting means.

41. A system as claimed in claim 33, wherein the second node further comprises transmitting means configured to transmit the encrypted first set of data to the first node.

42. A system as claimed in claim 33, wherein the second node further comprises a capturing means configured to capture the first set of data.

43. A system as claimed in claim 33, further comprising decrypting means for decrypting the encrypted first set of data using the second set of data.

44. A system as claimed in claim 42, wherein the decrypting means is configured to decrypt the encrypted first set of data by performing an exclusive OR operation between the encrypted first set of data and the second set of data.

45. A system as claimed in claim 36, wherein the first node comprises a first network archive server.

46. A system as claimed in claim 37, wherein the second node comprises a piece of user equipment.

47. A system as claimed in claim 45, wherein the piece of user equipment comprises one of a mobile station, a digital camera, a personal digital assistant or a personal computer.

48. A system as claimed in claim 38, wherein the third node comprises a second network server archive.

49. A system as claimed in claim 33, wherein the first set of data comprises one of a digital photograph, a picture or a text document, an audio file, or multimedia message.

50. A system as claimed in claim 33, wherein the second set of data comprises one of a thumbnail image, an extract from an audio file or a picture of a multimedia message.

51. A system as claimed in claim 33, wherein the system comprises a single entity.

52. A system as claimed in claim 33, wherein means are provided to delete the encrypted first set of data from the first node after the encrypted first set of data has been downloaded.

53. A system as claimed in claim 33, comprising a node for storing the encrypted first set of data.

54. A system as claimed in claim 52, wherein said node is a network archive server.
